(19) United States
(12) Patent Application Publication
(10) Pub. No.: US 2011/0085260 A1
(43) Pub. Date: Apr. 14, 2011

(54) DISK DRIVE AND SERVO CONTROL METHOD FOR THE DISK DRIVE THAT IS RESPONSIVE TO VIBRATION

(76) Inventors: Toshiaki WADA, Kanagawa (JP); Dongwon Lee, Kanagawa (JP); Xiaotian Sun, Saratoga, CA (US); Fu-Ying Huang, San Jose, CA (US)

(21) Appl. No.: 12/639,016

(22) Filed: Dec. 16, 2009

(30) Foreign Application Priority Data
Dec. 16, 2008 (JP) 2008-320330

(51) Int. Cl. G11B 21/02

(52) U.S. Cl. 360/75; G9B/21.003

(57) ABSTRACT

A disk drive. The disk drive includes an acceleration sensor, a servo controller, a detection determiner, and a handling processor. The acceleration sensor has an associated resonant frequency. The servo controller is configured to perform servo control for head positioning using frequency components that are obtained by cutting off frequency components including the resonant frequency from output of the acceleration sensor. The detection determiner is configured to detect a frequency band including the resonant frequency from the output of the acceleration sensor to determine whether a magnitude of a voltage amplitude of the frequency band is outside of a specified range. The handling processor is configured to execute a corresponding handling operation if the detection determiner determines that the magnitude of the voltage amplitude of the frequency band is outside of the specified range.

### CROSS-REFERENCE TO RELATED APPLICATION

This application claims priority from the Japanese Patent Application No. 2008-320330, filed Dec. 16, 2008, the disclosure of which is incorporated herein in its entirety by reference.

### TECHNICAL FIELD

Embodiments of the present invention relate to a disk drive and a servo control method for the disk drive that is responsive to vibration.

### BACKGROUND

Disk drives are known in the art that use various kinds of disks, such as: optical disks, magneto-optical disks, flexible magnetic-recording disks, and similar disk data-storage devices. In particular, hard-disk drives (HDDs) have been widely used as indispensable data-storage devices for current computer systems. Moreover, HDDs have found widespread application to motion picture recording and reproducing apparatuses, car navigation systems, cellular phones, and similar devices, in addition to the computers, because of their outstanding information-storage characteristics.

A magnetic-recording disk used in a HDD has multiple concentric data tracks and servo tracks. Each servo track contains multiple servo data portions having address information. Each data track includes multiple data sectors containing user data recorded on the data sectors. Data sectors are recorded between servo data in discrete portions of a track in the circumferential direction of the magnetic-recording disk. A magnetic-recording head of a head-slider supported by a rotary actuator accesses a designated data sector in accordance with address information in the servo data to write data to, or read data from, a data sector of the magnetic-recording disk.

Engineers and scientists engaged in HDD manufacturing and development are interested in the design of HDDs, which utilize servo control to position the magnetic-recording head accurately and reproducibly, so as to access data on the magnetic-recording disk, to meet the rising demands of the marketplace for increased data-storage capacity, performance, and reliability.

### SUMMARY

Embodiments of the present invention include a disk drive. The disk drive includes an acceleration sensor, a servo controller, a detection determiner, and a handling processor. The acceleration sensor has an associated resonant frequency. The servo controller is configured to perform servo control for head positioning using frequency components that are obtained by cutting off frequency components including the resonant frequency from output of the acceleration sensor. The detection determiner is configured to detect a frequency band including the resonant frequency from the output of the acceleration sensor to determine whether a magnitude of a voltage amplitude of the frequency band is outside of a specified range. The handling processor is configured to execute a corresponding handling operation if the detection determiner determines that the magnitude of the voltage amplitude of the frequency band is outside of the specified range.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is an example block diagram schematically depicting the configuration of a hard-disk drive (HDD), in accordance with an embodiment of the present invention.

FIG. 2 is an example block diagram schematically depicting the constituent elements related to operations of a hard-disk controller/microprocessor unit (HDC/MPU) in response to output of a vibration sensor, in accordance with an embodiment of the present invention.

FIG. 3 is an example flowchart illustrating determination of the existence of abnormal vibrations using output of the vibration sensor, and operations responsive to the abnormal vibrations, in accordance with an embodiment of the present invention.

FIG. 4 is an example block diagram schematically depicting a configuration example of a rotational vibration (RV) sensor, and a resonant frequency detection determiner, in accordance with an embodiment of the present invention.

FIG. 5 is an example drawing showing a circuit configuration example of the function blocks of the resonant frequency detection determiner shown in FIG. 4, in accordance with an embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

Description of Embodiments of the Present Invention for a Disk Drive and a Servo Control Method of the Disk Drive that is Responsive to Vibration

With relevance to embodiments of the present invention, a hard-disk drive (HDD) positions a head-slider using a rotary actuator. Accordingly, if a HDD receives external vibrations, the actuator vibrates so that the HDD may have difficulty in performing accurate head positioning. For this reason, as is known in the art, a vibration sensor may be mounted on the HDD for use in servo control. A vibration sensor suitable for use in a HDD is a rotational vibration (RV) sensor. The RV sensor is capable of detecting rotation and vibration. An RV sensor includes a sensor for directly detecting rotational vibrations, or alternatively, two uniaxial acceleration sensors for detecting vibrations in a linear direction. The two uniaxial acceleration sensors are disposed at different places on a circuit board and are capable of detecting vibration and rotation in an in-plane direction of the recording surface of the magnetic-recording disk 11.

Incorporating the result detected by the RV sensor into servo control for head positioning, which is also referred to herein as “servo positioning,” by means of feed-forward control, leads to suppression of the influence of external vibrations on the servo positioning. In particular, in a system having a plurality of HDDs placed in close proximity to each other, for example, as in a server system, the vibrations caused by operations of other HDDs can affect servo positioning of a HDD. Accordingly, a technique for detecting rotation and vibration using an RV sensor and for servo control responsive to the detected rotations and vibrations is utilized.

A HDD may also include a shock sensor for detecting impact in addition to the RV sensor for detecting vibration, as is known in the art. In general, shock sensors detect vibrations at higher frequency than RV sensors. A shock applied to a HDD from a source external to the HDD, or alternatively, displacement of the internal components of the HDD caused by an abrupt temperature change, may cause a shock. Usually, a period, which is a time duration, of the shock is short; and, the frequency in the head vibrations caused by the shock is higher than the servo sampling frequency. Hence, when a HDD has detected a shock, the HDD inhibits a write operation to prevent an off-track write.

Moreover, control to extract predetermined low frequency components out of the output of the shock sensor is known in the art for compensating for mechanical destabilization in a write operation; and, furthermore, control to extract high frequency components is known in the art for determining a write inhibit operation. Thus, with a single shock sensor, vibration compensation in servo control and control for write enable or inhibit may be provided.

As is known in the art, frequency components may be extracted in a specific band lower than the resonant frequency of the shock sensor, and the extracted frequency components may be employed be compared against a reference level for determination of write enable or inhibit. However, the vibration frequency, which causes an off-track displacement of a head-slider, or other displacement of the head-slider over the range for normal servo control, may not be due to vibrations in a specific high frequency band. Moreover, with increases in the capacity of HDDs that has attended the advances in HDD technology, data track pitch is becoming smaller and smaller. Hence, even if receiving a marginal shock, the head-slider, or alternatively, the actuator to which the head-slider is attached, is likely to move to an adjacent data track to overwrite the adjacent track, which is referred to by the term of art, “off-track write.”

Embodiments of the present invention are able to detect external vibrations in a wide band that disturb normal servo control for head-slider positioning, and furthermore, are able to detect a small shock with high sensitivity, in detecting a shock and vibrations at low frequencies using a vibration sensor, or alternatively, a shock sensor.

In accordance with embodiments of the present invention, a disk drive includes an acceleration sensor, a servo controller, a detection determiner, and a handling processor. In accordance with embodiments of the present invention, the acceleration sensor has an associated resonant frequency; and, the servo controller is configured to perform servo control for head positioning using frequency components that are obtained by cutting off frequency components including the resonant frequency from output of the acceleration sensor. Moreover, in accordance with embodiments of the present invention, a detection determiner is configured to detect a frequency band including the resonant frequency from the output of the acceleration sensor to determine whether a magnitude of a voltage amplitude of the frequency band is outside of a specified range; and, a handling processor is configured to execute a corresponding handling operation if the detection determiner determines that the magnitude of the voltage amplitude of the frequency band is outside of the specified range. Thus, in an embodiment of the present invention, a disk drive, which performs control responsive to vibrations, provides a reduction in the number of components, and increased vibration detection for servo control.

In one embodiment of the present invention, the disk drive includes a plurality of acceleration sensors; the servo controller is configured to use frequency components that are obtained by cutting off frequency components including respective resonant frequencies of the plurality of acceleration sensors from respective outputs of the plurality of acceleration sensors; and, the detection determiner is configured to perform a determination on a magnitude of a voltage amplitude of a sum of frequency bands including the respective resonant frequencies of the plurality of acceleration sensors. Thus, in an embodiment of the present invention, various vibrations may be detected more properly.

In another embodiment of the present invention, the handling processor is configured to inhibit a write operation of user data as the handling operation. Thus, in an embodiment of the present invention, an off-track write may be prevented effectively. Alternatively, in another embodiment of the present invention, the handling processor is configured to change modes in the servo control as the handling operation. Thus, in an embodiment of the present invention, proper servo control responsive to the vibrations may be provided.

In another embodiment of the present invention, the handling processor is configured to inhibit a write operation of user data as the handling operation, and is configured to change modes in the servo control if the determination by the detection determiner that the magnitude of the voltage amplitude of the frequency band is outside of the specified range satisfies a predetermined condition. Thus, in an embodiment of the present invention, proper servo control responsive to the vibrations may be provided. In another embodiment of the present invention, the detection determiner is configured with analog circuits. Thus, in an embodiment of the present invention, swift vibration detection may be provided.

In accordance with embodiments of the present invention, a control method is provided that is responsive to vibrations in a disk drive. In accordance with embodiments of the present invention, the method performs servo control for head positioning using frequency components obtained by cutting off frequency components, including the resonant frequency that is associated with an acceleration sensor, from the output of the acceleration sensor. In accordance with embodiments of the present invention, the method detects a frequency band including the resonant frequency from the output of the acceleration sensor to determine whether a magnitude of a voltage amplitude of the frequency band is outside of a specified range. In accordance with embodiments of the present invention, the method executes a handling operation corresponding to a determination, if the determination is that the magnitude of the voltage amplitude of the frequency band is outside of the specified range. Thus, in an embodiment of the present invention, in a disk drive which performs control responsive to vibrations, the method reduces the number of components and provides increased vibration detection for the servo control.

Embodiments of the present invention are subsequently described by way of example of: a HDD, which is an example of a disk drive; a magnetic-recording head, which is an example of a head; and, a magnetic-recording disk, which is an example of a disk. In accordance with embodiments of the present invention, a HDD includes a vibration sensor and corrects servo control, which is servo positioning, in head positioning using the output value of the sensor. In an embodiment of the present invention, the vibration sensor to be used for the correction in servo positioning targets vibrations at low frequencies, for example, 100 hertz (Hz) to several kilohertz. In another embodiment of the present invention, the vibration sensor oscillates at a resonant frequency, which is referred to as the self oscillation frequency, in response to an excessive input, or alternatively, to an input at high frequency. Then, in another embodiment of the present invention, the HDD cuts the high frequency components including the resonant frequency, for example, at several tens of kilohertz, in the vibration sensor output to use the low frequency components in the vibration sensor output in servo control. Thus, in an embodiment of the present invention, accurate servo control using a vibration sensor is provided to improve the performance of the HDD.

Moreover, in another embodiment of the present invention, the HDD monitors the voltage amplitude of a frequency band including the resonant frequency, which is associated with the vibration sensor to perform operations in response to abnormal vibrations such as a shock, or alternatively, excessive vibrations. Thus, in accordance with embodiments of the present invention, performing servo control and abnormal vibration handling operations using a single vibration sensor enables control operations corresponding to various kinds of vibration within the HDD with a smaller number of components. Moreover, in accordance with embodiments of the present invention, monitoring a frequency band with upper and lower cut-off frequencies enables selective extraction of the resonant frequency for determining the presence of abnormal vibration with more accuracy.

A shock has a short time duration, and provides a vibration sensor with a high-frequency input. In an embodiment of the present invention, the vibration sensor has high sensitivity at the resonant frequency. Then, in accordance with embodiments of the present invention, the output of the vibration sensor at the resonant frequency is large even for a small impact, so that the vibration sensor may detect an external impact with high accuracy. Furthermore, in accordance with embodiments of the present invention, if there are large-amplitude vibrations at low frequencies, the vibration sensor produces a large output at the resonant frequency. Thus, in accordance with embodiments of the present invention, effective handling is provided for abnormal vibrations of excessive vibrations at low frequencies. Before describing details of control of a HDD responsive to vibrations in accordance with embodiments of the present invention, a configuration of a HDD is next described.

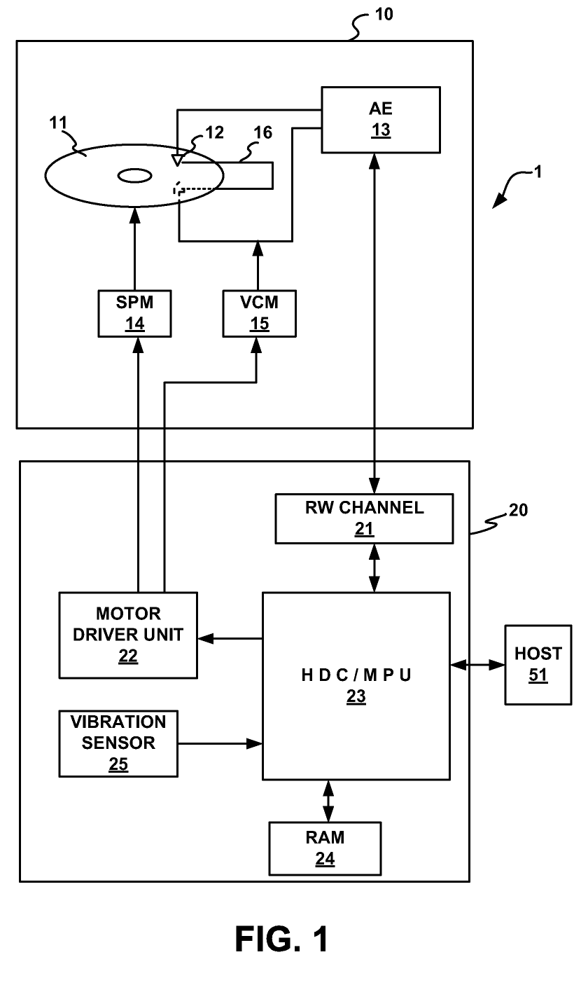

With reference now to FIG. 1, in accordance with an embodiment of the present invention, a block diagram is shown that schematically depicts the configuration of HDD 1. HDD 1 includes a magnetic-recording disk 11, which is a disk for storing data, inside an disk enclosure (DE) 10. A spindle motor (SPM) 14 spins the magnetic-recording disk 11 at a specific angular rate. Head-sliders 12 are provided to access, for example, for reading data from, or for writing data to, the magnetic-recording disk 11; each of the head-sliders 12 correspond to a respective recording surface of a magnetic-recording disk 11.

As used herein, “access” is a term of art that refers to operations in seeking a data track of a magnetic-recording disk and positioning a magnetic-recording head on the data track for both reading data from, and writing data to, a magnetic-recording disk, for example, magnetic-recording disk 11. Each head-slider 12 includes a slider for flying above the magnetic-recording disk and a magnetic-recording head fixed to a slider for converting a magnetic signal to and from an electric signal. Each head-slider 12 is fixed to a distal end of an actuator 16. The actuator 16, which is coupled to a voice coil motor (VCM) 15, pivots on a pivot shaft to move the head-sliders 12 above the spinning magnetic-recording disk 11 in nominally the radial direction of the magnetic-recording disk 11. A moving mechanism for the head-sliders 12 includes both the actuator 16 and the VCM 15.

On a circuit board 20 fixed outside the DE 10, circuit elements are mounted. A motor driver unit 22 drives the SPM 14 and the VCM 15 in accordance with control data from a hard-disk controller/microprocessor unit (HDC/MPU) 23. A random access memory (RAM) 24 functions as a buffer for temporarily storing read data and write data. An arm electronics (AE) module 13 inside the DE 10 selects a head-slider 12 to access the magnetic-recording disk 11 from multiple head-sliders 12, amplifies a read-back signal from the head-slider 12 to send the read-back signal to a read-write channel (RW channel) 21. Furthermore, AE module 13 sends a write signal from RW channel 21 to the selected head-slider 12.

RW channel 21, in a read operation, amplifies the read-back signal supplied from AE module 13 to have a predetermined amplitude, extracts data from the obtained read-back signal, and decodes the data. The read data includes user data and servo data. The decoded read user data and servo data are supplied to HDC/MPU 23. RW channel 21, in a write operation, code-modulates write data supplied from HDC/MPU 23, converts the code-modulated data into a write signal, and then supplies the write signal to AE module 13.

HDC/MPU 23, an example of a controller for HDD 1, performs control of HDD 1 in addition to other processes concerning data processing, such as: read/write operation control; command execution order management; positioning control of the head-sliders 12 using a servo signal, which referred to also as “servo positioning;” interface control to and from a host 51; defect management; and error handling operations when any error occurs.

In accordance with an embodiment of the present invention, HDC/MPU 23 corrects servo positioning using feed-forward control responsive to the vibrations sensed by a vibration sensor 25. Furthermore, HDC/MPU 23 extracts a specific frequency band including the resonant frequency of the vibration sensor 25 from the output of the vibration sensor 25, and performs an abnormal vibration handling operation in accordance with the voltage amplitude of the frequency band.

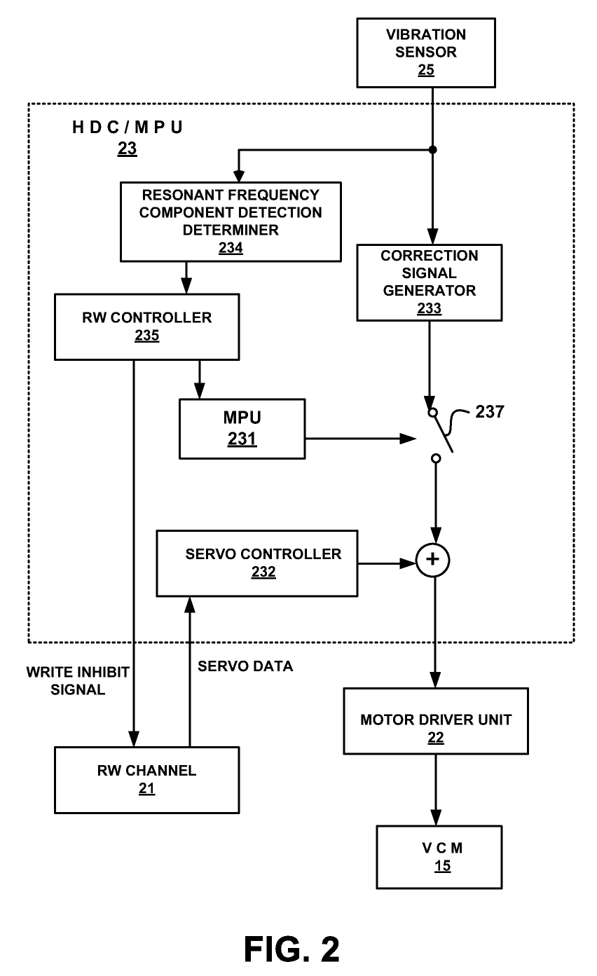

With reference now to FIG. 2, in accordance with an embodiment of the present invention, a block diagram is shown that schematically illustrates constituent elements related to operations of HDC/MPU 23 in accordance with the output of the vibration sensor 25. First, head positioning by HDC/MPU 23 is next described. HDC/MPU 23 includes a servo controller 232, which calculates a position error signal (PES) between a target data track and the servo data, which is associated with the current position of the magnetic-recording head, obtained from RW channel 21 which digitizes a servo signal read by the head-slider 12, and determines the VCM current so that the absolute value of the PES is minimized.

A correction signal generator 233 calculates a correction value for servo positioning from the output of the vibration sensor 25. The correction signal generator 233 extracts low-frequency components from the output of the vibration sensor 25 to calculate the correction value from the low-frequency components from the output of the vibration sensor 25. The frequency band used by the correction signal generator 233 does not include the resonant frequency, which is associated with the vibration sensor 25. The frequencies used by the correction signal generator 233 are smaller than the servo sampling frequency, and are typically frequency components under several kilohertz.

When a switch 237 is ON, the output value of the servo controller 232 is added to a correction value from the correction signal generator 233, and is transferred to the motor driver unit 22. When the switch 237 is OFF, the output value of the servo controller 232 is not corrected, and is transferred to the motor driver unit 22, as is. The motor driver unit 22 supplies the VCM 15 with VCM current in accordance with the control data obtained from HDC/MPU 23. MPU 231, which works in accordance with firmware, controls the switch 237, which is subsequently described.

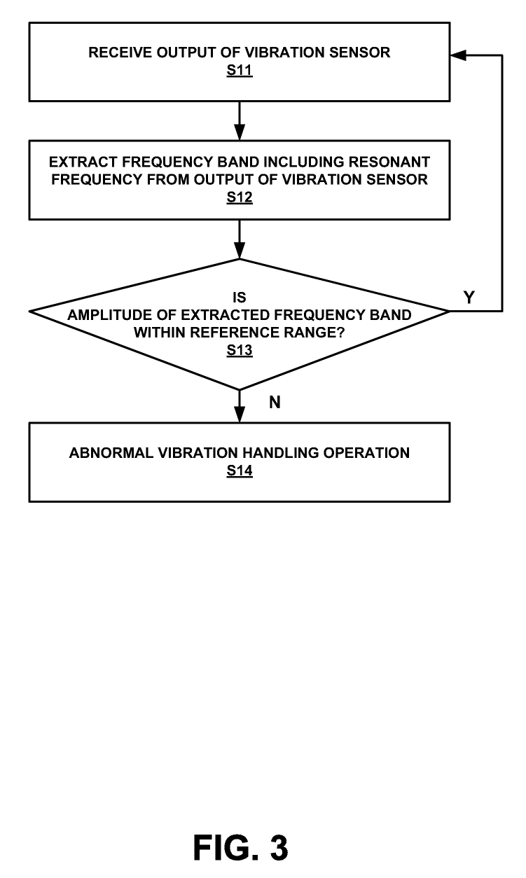

Correction control for head positioning using feed-forward of the output of the vibration sensor 25 provides more accurate servo positioning even though external vibrations exist. In this regard, alternatively, the motor driver unit 22 may include the correction signal generator 233 and the switch 237; and, HDC/MPU 23 may control the switch 237. In such a configuration, the detection value of the vibration sensor 25 is input into the motor driver unit 22; and, a portion of the motor driver unit 22 functions as a controller. The functions of HDC/MPU 23 may be performed by MPU 231, or alternatively, by other of the hardware circuits. Determination of presence of abnormal vibrations using the output of the vibration sensor 25 and operations responsive to the abnormal vibrations are next described with reference to the block diagram of FIG. 2 and the flowchart of FIG. 3.

With reference now to FIG. 3, in accordance with an embodiment of the present invention, a flowchart is shown that illustrates determination of the existence of abnormal vibrations using output of the vibration sensor, and operations responsive to the abnormal vibrations. HDC/MPU 23 monitors a frequency band including the frequency in a resonant mode, which is a resonant frequency, in the output of the vibration sensor 25. If the voltage amplitude is above a reference level, HDC/MPU 23 determines that abnormal vibrations exist, and performs abnormal vibration handling operations. A resonant frequency detection determiner 234, which is a function block in HDC/MPU 23, at S11, receives the output of the vibration sensor 25, and, at S12, extracts a specific frequency band including the resonant frequency.

Furthermore, at S13, the resonant frequency detection determiner 234 determines whether the magnitude of the voltage amplitude in the specific frequency band is within a reference range defined with a threshold. If it is within the reference range (Y-branch after S13), the resonant frequency detection determiner 234 continues to monitor the specific frequency band, at S11. If the magnitude of the voltage amplitude in the frequency band is outside of the reference range (N-branch after S13), HDC/MPU 23 determines that there exist abnormal vibrations, and starts operations responsive to the abnormal vibrations, at S14.

In one embodiment of the present invention, an abnormal vibration handling operation includes the data write inhibit operation. If the resonant frequency detection determiner 234 determines that abnormal vibrations, for example, a shock, or alternatively, excessive continuous vibrations, have occurred, because the magnitude of the voltage amplitude of the specific frequency band is not within the predetermined reference range, the resonant frequency detection determiner 234 notifies an RW controller 235 of the determination result. RW controller 235 performs timing control in reading and writing user data. RW controller 235 sends a gate signal, which is a timing control signal for read/write, to RW channel 21.

If a write gate is ON, RW channel 21 sends a write signal to the AE module 13. If RW controller 235 receives an error notice from the resonant frequency detection determiner 234 during a data write operation, RW controller 235 turns off the write gate to inhibit the write operation. At the resonant frequency, the output of the vibration sensor 25 has a great gain. Then, the resonant frequency detection determiner 234 is able to accurately detect a small shock from the output of the vibration sensor 25, preventing an off-track write with fewer write errors in a HDD with small track pitch.

In this instance, in an embodiment of the present invention, the resonant frequency detection determiner 234 and RW controller 235 are hardware organized as exemplified in FIG. 2. Thus, in an embodiment of the present invention, an off-track write may be reliably prevented by an instant data write inhibit independent from the operation clock frequency of MPU 231.

In another embodiment of the present invention, an abnormal vibration handling operation may also include the mode control in servo positioning. The servo positioning by HDC/MPU 23 includes a correction servo mode for making correction using the output of the vibration sensor 25, and a normal servo mode for performing servo positioning without vibration compensation. As described above, MPU 231 turns the switch 237 on or off to enable or disable the vibration correction function. The servo mode with the switch 237 turned on is the correction servo mode; and, the servo mode with the switch 237 turned off is the normal servo mode.

After RW controller 235 has inhibited a data write operation in response to abnormal vibration detection by the resonant frequency detection determiner 234, RW controller 235 notifies MPU 231 so doing. If the occurrence condition of the write inhibit event, such as the frequency of the events, or alternatively, the time intervals of the events, are outside of designated limits, MPU 231 turns off the switch 237 to set the servo mode to a normal mode in which no correction is made. For example, if large-amplitude vibrations at low frequencies instead of vibrations with a short duration, for example, a shock, are applied continuously, the feed-forward control function of the vibration sensor 25 impairs the accuracy in servo positioning. The vibration sensor 25 oscillates by itself in response to such vibrations to produce high output at the resonant frequency.

Then, if RW controller 235 repeats a write inhibit in a short term responsive to the output of the vibration sensor 25, MPU 231 determines that abnormal vibrations have occurred from the continuous excessive vibrations, and stops the vibration compensation function in servo positioning. Thus, in an embodiment of the present invention, more accurate servo positioning may be provided even under continuous large-amplitude vibrations. For example, if the time interval between the previous event occurrence and the present event occurrence is less than a specified value, or alternatively, if greater than a designated number of event occurrences occurs within a specified time period, MPU 231 turns off the switch 237 to set the servo mode to the normal mode in which no correction is made.

In this way, for stable control, in an embodiment of the present invention, HDC/MPU 23 discontinues the correction function using output of the vibration sensor in changing the servo mode in response to abnormal vibrations. Depending on the design, in the servo mode control responsive to abnormal vibrations, the gain in the feed-forward control may be set smaller. Thus, in an embodiment of the present invention, the compensation amount by the output of the vibration sensor becomes smaller to suppress the degradation in accuracy in servo positioning.

In an embodiment of the present invention, HDC/MPU 23 has both the write inhibit function, and the servo mode control function. However, in the case that HDC/MPU 23 has just one or the other function, the effects of the function may be attained within HDD 1. MPU 231 may receive the determination result, which is one of the events, that there exist abnormal vibrations from the resonant frequency detection determiner 234 to control the servo mode based on the determination result.

As described above, even in the case that the write inhibit by RW controller 235 is used as a reference event in the servo mode control, since RW controller 235 determines the write inhibit based on the determination result of the resonant frequency detection determiner 234, MPU 231 monitors the event for abnormal vibration determination by the resonant frequency detection determiner 234 through RW controller 235.

In accordance with embodiments of the present invention, the write inhibit and the servo mode control have been described as handling operations for abnormal vibrations; but, HDC/MPU 23 may perform other abnormal vibration handling operations. For example, HDC/MPU 23 may unload the actuator 16 in response to the determination of the resonant frequency detection determiner 234, such that the head-slider 12 and the magnetic-recording disk 11 are protected from an external impact.

In another embodiment of the present invention, the vibration sensor 25 to be used in servo positioning in HDD 1 is a rotational vibration sensor (RV sensor). Typically, the vibration sensor 25 is mounted on a control-circuit board 20. The RV sensor 25 detects rotations and vibrations in directions parallel to the recording surface of the magnetic-recording disk 11. In another embodiment of the present invention, a configuration and operation of the resonant frequency detection determiner 234 in HDD 1 having an RV sensor as the vibration sensor 25 is next described.

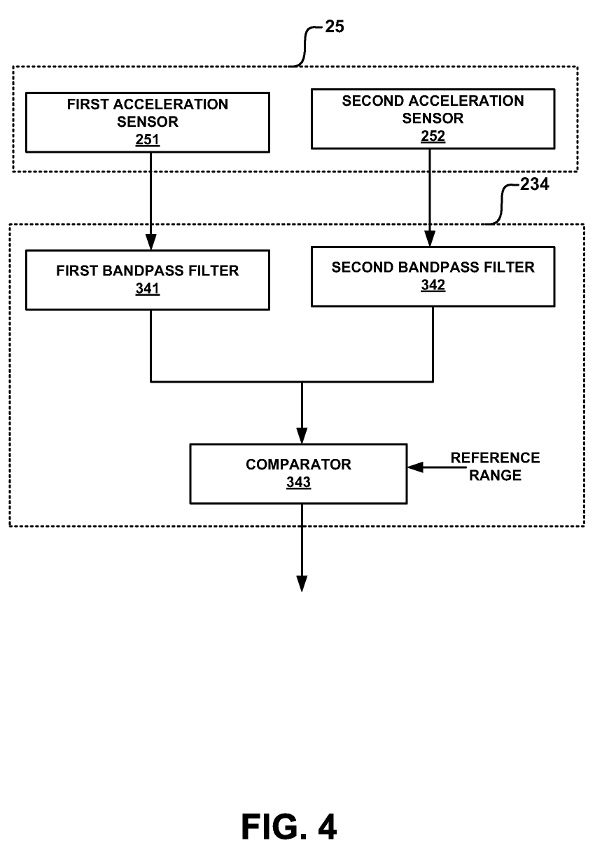

With reference now to FIG. 4, in accordance with an embodiment of the present invention, a block diagram is shown that schematically illustrates a configuration example of the RV sensor 25 and the resonant frequency detection determiner 234. The RV sensor 25 includes two uniaxial acceleration sensors of a first acceleration sensor 251 and a second acceleration sensor 252. These are disposed on different places on a control-circuit board 20. The RV sensor 25 senses rotations and vibrations from the outputs of these two acceleration sensors 251 and 252. Typically, the properties of the two acceleration sensors 251 and 252 are the same.

The resonant frequency detection determiner 234 includes a first bandpass filter 341, a second bandpass filter 342, and a comparator 343. The first bandpass filter 341 extracts a specific frequency band including the resonant frequency of the first acceleration sensor 251 from the output of the first acceleration sensor 251. The second bandpass filter 342 extracts a frequency band including the resonant frequency of the second acceleration sensor 252 from the output of the second acceleration sensor 252. To properly extract the resonant frequencies, in an embodiment of the present invention, the lower cut-off frequencies of the bandpass filters 341 and 342 are more than one fourth of the respective resonant frequencies, and the higher cut-off frequencies of the bandpass filters 341 and 342 are less than four times of the respective resonant frequencies.

The comparator 343 receives the sum of the output of the first bandpass filter 341 and the output of the second bandpass filter 342. The comparator 343 determines whether the sum is within a predetermined reference range. In another configuration in accordance with an embodiment of the present invention, the reference range is defined by a lower threshold and an upper threshold. The outputs, which may be voltage amplitudes, of the acceleration sensors 251 and 252 are oscillating with respect to a reference potential; and, if large-amplitude vibrations occur, the voltage amplitudes will increase. Whether occurrence of abnormal vibrations first appears in upper or lower voltage amplitude is unknown; but, in an embodiment of the present invention, the amplitude is able to be detected that occurs first. Accordingly, the comparator 343 includes two thresholds, a lower threshold and an upper threshold; and, if the voltage amplitudes oscillating up and down from the bandpass filters 341 and 342 exceed either threshold, the comparator 343 notifies RW controller 235 of an occurrence of abnormal vibrations.

If the input to the comparator 343 is outside of the reference range defined by the thresholds, the comparator 343 notifies RW controller 235 of an occurrence of abnormal vibrations. In another configuration in accordance with an embodiment of the present invention, the comparator 343 performs comparison of the sum of the outputs of the two bandpass filters 341 and 342 as described above. Since the direction of the vibrations applied to the HDD is not fixed, referring to both of the outputs of the two filters leads to proper comparison determination regardless of the vibration direction. Moreover, a single comparator may compare two outputs, so the circuit configuration may be made simple. Depending on the design, comparators may be provided for the two respective bandpass filters 341 and 342. Otherwise, the comparison may be performed by referring to the output of either filter alone.

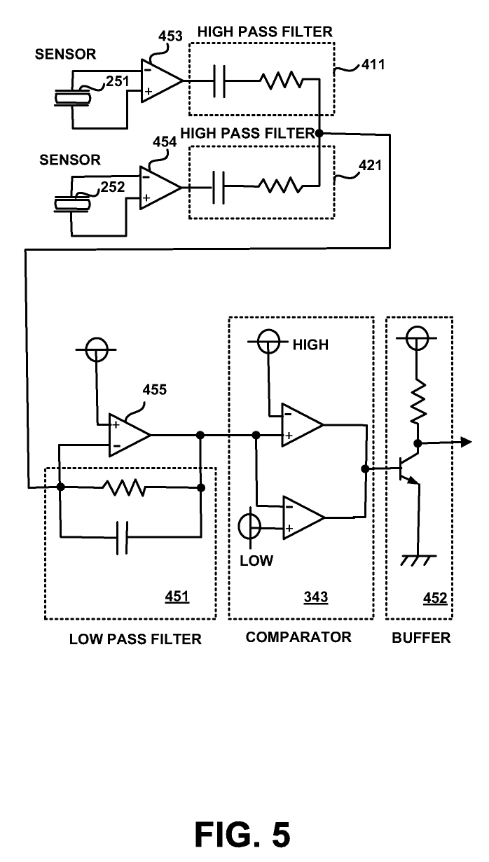

With reference now to FIG. 5, in accordance with an embodiment of the present invention, a drawing is shown of a circuit configuration example of the function blocks to configure the resonant frequency detection determiner 234 shown in FIG. 4. The first bandpass filter 341 consists of a first-order highpass filter 411 and a first-order lowpass filter 451. The second bandpass filter 342 consists of a first-order highpass filter 421 and a first-order lowpass filter 451. The lowpass filer 451 is commonly used in the two bandpass filters 341 and 342. To the comparator 343, a HIGH voltage and a LOW voltage are given as the upper threshold and the lower threshold, respectively. The output of the comparator 343 is sent to an external component block, for example, RW controller 235, through a buffer circuit 452 in an output stage.

The output of the first acceleration sensor 251 is amplified by an amplifier 453; and, the low frequency components under the cut-off frequency are cut by the highpass filter 411. At this time, DC offset and low band noise in the output of the first acceleration sensor 251 are cut off. The output of the second acceleration sensor 252 is amplified by an amplifier 454 and the low frequency components under the cut-off frequency are cut by the highpass filter 421. At this time, DC offset and low band noise in the output of the second acceleration sensor 252 are cut off.

The outputs from the highpass filters 411 and 421 are subjected to analog addition. The acceleration sensor, which detects abnormal vibrations earlier, differs depending on the place, or the direction, of the abnormal vibrations. The use of analog added outputs of the two acceleration sensors 251 and 252 allows the use of the signal of the acceleration sensor, which has detected abnormal vibrations earlier, regardless of the place, or the direction, of the abnormal vibrations.

The analog added signal is sent to a secondary amplifier 455 for gain adjustment. To the feedback of the secondary amplifier 455, the lowpass filter 451 is connected. The lowpass filter 451 removes high frequency components in unwanted noise. Thus, in an embodiment of the present invention, a frequency band including the resonant frequency is extracted.

The output of the secondary amplifier 455 enters the comparator 343. The operating center of the comparator 343 agrees with the DC offset of the amplifier 455. The comparator 343 compares the voltage amplitude of the input from the secondary amplifier 455 with the two thresholds HIGH and LOW. If the voltage amplitude is outside of the range from LOW to HIGH, namely if it is higher than HIGH, or alternatively, lower than LOW, the comparator 343 notifies RW controller 235 of an occurrence of abnormal vibrations.

The filter to extract the resonant frequency from the output of the vibration sensor 25 may be configured with a higher order filter, but not a first-order filter. Even if the resonant frequency detection determiner 234 is configured with another circuit configuration, in an embodiment of the present invention, the resonant frequency detection determiner 234 is configured with analog circuits. As described above, for reliability, higher process speed is utilized for the abnormal vibration handling operation. The resonant frequency detection determiner 234 including analog circuits provides determination of abnormal vibration detection at a suitable process speed independent from the operating clock frequency of the control circuit.

As set forth above, embodiments of the present invention have been described by way of examples; but, embodiments of the present invention are not limited to the above-described examples, as embodiments of the present invention can, of course, be modified, added to, and/or elements of the examples converted in various ways within the spirit and scope of embodiments of the present invention. For example, embodiments of the present invention include disk drives with data-storage disks other than magnetic-recording disks used in HDDs, such as: optical disks, and magneto-optical disks, by way of example without limitation thereto. By way of further example, embodiments of the present invention include a HDD having a shock sensor, instead of a vibration sensor. Since both a shock sensor and a vibration sensor use acceleration sensors, in accordance with embodiments of the present invention, a HDD may extract the resonant frequency from the output of the acceleration sensor to provide more proper control responsive to abnormal vibrations.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A disk drive comprising:
an acceleration sensor having an associated resonant frequency;
a servo controller for performing servo control for head positioning using frequency components that are obtained by cutting off frequency components comprising said resonant frequency from output of said acceleration sensor;
a detection determiner for detecting a frequency band comprising said resonant frequency from said output of said acceleration sensor to determine whether a magnitude of a voltage amplitude of said frequency band is outside of a specified range; and
a handling processor for executing a corresponding handling operation if said detection determiner determines that said magnitude of said voltage amplitude of said frequency band is outside of said specified range.

2. The disk drive of claim 1, further comprising:
a plurality of acceleration sensors;
wherein said servo controller is configured to use frequency components that are obtained by cutting off frequency components comprising respective resonant frequencies of said plurality of acceleration sensors from respective outputs of said plurality of acceleration sensors; and
wherein said detection determiner is configured to perform a determination on a magnitude of a voltage amplitude of a sum of frequency bands comprising said respective resonant frequencies of said plurality of acceleration sensors.

3. The disk drive of claim 1, wherein said handling processor is configured to inhibit a write operation of user data as said handling operation.

4. The disk drive of claim 1, wherein said handling processor is configured to change modes in said servo control as said handling operation.

5. The disk drive of claim 1, wherein said handling processor is configured to inhibit a write operation of user data as said handling operation; and is configured to change modes in said servo control if a determination by said detection determiner that said magnitude of said voltage amplitude of said frequency band is outside of said specified range satisfies a predetermined condition.

6. The disk drive of claim 1, wherein said detection determiner is configured with analog circuits.

7. A control method responsive to vibrations in a disk drive, said control method comprising:
performing servo control for head positioning using frequency components obtained by cutting off frequency components, comprising a resonant frequency that is associated with an acceleration sensor, from output of said acceleration sensor;
detecting a frequency band comprising said resonant frequency from said output of said acceleration sensor to determine whether a magnitude of a voltage amplitude of said frequency band is outside of a specified range; and
executing a handling operation corresponding to a determination, if said determination is that said magnitude of said voltage amplitude of said frequency band is outside of said specified range.

8. The control method of claim 7, wherein said servo control uses frequency components obtained by cutting off frequency components comprising respective resonant frequencies of a plurality of acceleration sensors from respective outputs of said acceleration sensors; and
detection detects a sum of frequency bands comprising said respective resonant frequencies of said plurality of acceleration sensors.

9. The control method of claim 7, wherein said handling operation is a write inhibit operation of user data.

10. The control method of claim 7, wherein said handling operation is changing modes in said servo control.

11. The control method of claim 7, wherein said handling operation inhibits a write operation of user data in response to said determination by a detection determiner that there exist abnormal vibrations, and changes modes in said servo control if said determination by said detection determiner that there exist abnormal vibrations satisfies a predetermined condition.
